(19) United States
(12) Patent Application Publication
(10) Pub. No.: US 2011/0014594 A1
(43) Pub. Date: Jan. 20, 2011

(54) Adaptive Foreign-Language-Learning Conversation System Having a Dynamically Adjustable Function

(76) Inventors: Shing-Lung Chen, Kaohsiung (TW); Chen-Sung Chang, Nantou County (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/647,113

(22) Filed: Dec. 24, 2009

(30) Foreign Application Priority Data
Jul. 16, 2009 (TW) 098124408

(51) Int. Cl. G09B 19/06

(52) U.S. Cl. 434/157

(57) ABSTRACT

An adaptive foreign-language-learning conversation system includes conversation-graded sets, conversation topic units provided in the conversation-graded sets, and conversation modules provided in the conversation topic units and including predetermined conversation sentences, conversation indexes, and conversation routes. The conversation sentences define conversation simulation files and the conversation module is used to generate the conversation sentence and to receive and identify a user's response sentence. A conversation-evaluating unit is provided in the conversation-graded set to connect with output ends of the conversation topic units, and is used to generate an evaluation result. The system is operated to upgrade or downgrade levels of the conversation-graded sets, or to maintain the same level of the conversation-graded sets according to the evaluation result.

### BACKGROUND OF THE INVENTION

1. Field of the Invention

The present invention relates to an adaptive foreign-language-learning conversation system having a dynamically adjustable function. More particularly, the present invention relates to the adaptive foreign-language-learning conversation system having a dynamically adjustable function, according to user's learning statuses, for individual users.

2. Description of the Related Art

Taiwanese patent application publication No. 200841283, entitled “Diagnostic and consulting system for language learning,” discloses a language-learning-status diagnosing and consulting system for learning foreign language. The diagnosing and consulting system requires: containing a plurality of files of case histories and study records; providing personalized learning programs and learning progress schedules thereof; adjusting the learning progress schedules according to individual learning efficiencies; evaluating the individual learning efficiencies. The diagnosing and consulting system can be adjusted according individual learning backgrounds, learning methods, learning tendencies, and learning difficulties so as to aid user's learning efficiency.

As has been discussed above, the diagnosing and consulting system can only be used to adjust the personalized learning programs and learning progress schedules according to the individual user's learning efficiency. However, the diagnosing and consulting system is absent an adaptive foreign-language-learning system that has a dynamically adjustable function or the like for individual users.

Taiwanese patent publication No. 1277020, entitled “Conversation ability testing system,” discloses a testing system connecting a main TV phone terminal with a testing TV phone terminal via a network. Test images are read from a video/audio memory device to convey and to display on the testing TV phone terminal. In testing, a user can interactively response the test image displayed on the testing TV phone terminal such that the user's conversation ability can be evaluated according to the interaction of the user with the test images.

As has been discussed above, the conversation ability testing system can only function to test the conversation ability of the user. However, the conversation ability testing system is also absent an adaptive foreign-language-learning system that has a dynamically adjustable function or the like for individual users.

Hence, there exists a need of providing a foreign-language-learning system that is an adaptive system capable of dynamically adjusting language-learning levels according to user's conversation ability or learning statuses.

As is described in greater detail below, the present invention provides an adaptive foreign-language-learning conversation system having a dynamically adjustable function. The system utilizes a plurality of conversation modules and at least one conversation-evaluating unit to generate an adaptive evaluation result which is used to dynamically adjust learning levels of individual users in such a way as to mitigate and overcome the above problem.

### SUMMARY OF THE INVENTION

The primary objective of this invention is to provide an adaptive foreign-language-learning conversation system having a dynamically adjustable function. The system utilizes a plurality of conversation modules and at least one conversation-evaluating unit to generate an adaptive evaluation result which is used to dynamically adjust learning levels of individual users. Accordingly, the system of the present invention is successful in dynamically adjusting the learning levels according to user's conversation ability.

The adaptive foreign-language-learning conversation system in accordance with an aspect of the present invention includes:

a plurality of conversation-graded sets executed to simulate foreign language learning;

a plurality of conversation topic units provided in the corresponding conversation-graded sets;

a plurality of conversation modules provided in the corresponding conversation topic units, each of the conversation modules including predetermined conversation sentences, conversation indexes and conversation routes, the predetermined conversation sentences defining a plurality of conversation simulation files, the conversation modules used to generate one of the conversation sentences and to receive and identify a user's response sentence; and

at least one conversation-evaluating unit provided in at least one of the conversation-graded sets to connect with output ends of the conversation topic units, the conversation-evaluating unit used to generate an evaluation result while executing the conversation module of the conversation topic unit for simulating conversation;

wherein the system is operated to upgrade or downgrade levels of the conversation-graded sets, or to maintain the same level of the conversation-graded sets according to the evaluation result.

In a separate aspect of the present invention, the system further includes a plurality of grade-judging units connecting with the corresponding conversation-graded sets, and the grade-judging unit is used to upgrade or downgrade the levels of the conversation-graded sets, or to maintain the same level of the conversation-graded sets according to the evaluation result.

In a further separate aspect of the present invention, the grade-judging unit includes a first predetermined value and a second predetermined value which are used to upgrade or downgrade the levels of the conversation-graded sets, or to maintain the same level of the conversation-graded sets.

In yet a further separate aspect of the present invention, the conversation module connects with a conversation-guiding unit which is used to generate at least one option of the predetermined conversation sentences in the conversation module while the system is unsuccessful in identifying the user's response sentence.

In yet a further separate aspect of the present invention, the predetermined conversation sentences are in the form of various question sentences and answer sentences.

In yet a further separate aspect of the present invention, the conversation route links the associated conversation simulation files of the conversation modules.

In yet a further separate aspect of the present invention, the predetermined conversation sentences of the conversation modules connect with the conversation indexes.

In yet a further separate aspect of the present invention, the conversation indexes are selected from a complex index.

Further scope of the applicability of the present invention will become apparent from the detailed description given hereinafter. However, it should be understood that the detailed description and specific examples, while indicating preferred embodiments of the invention, are given by way of illustration only, since various modifications will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of an adaptive foreign-language-learning conversation system having a dynamically adjustable function in accordance with a preferred embodiment of the present invention.

FIG. 2 is a block diagram of conversation-graded sets applied in the adaptive foreign-language-learning conversation system in accordance with the preferred embodiment of the present invention.

FIG. 3 is a block diagram of conversation modules applied in the adaptive foreign-language-learning conversation system in accordance with the preferred embodiment of the present invention.

### DETAILED DESCRIPTION OF THE INVENTION

It is noted that an adaptive foreign-language-learning conversation system having a dynamically adjustable function in accordance with the present invention can be implemented by computer-executable process steps on a variety of different computing equipment, including stand-alone personal computers, networked computers, laptop computers, workstations, or the like.

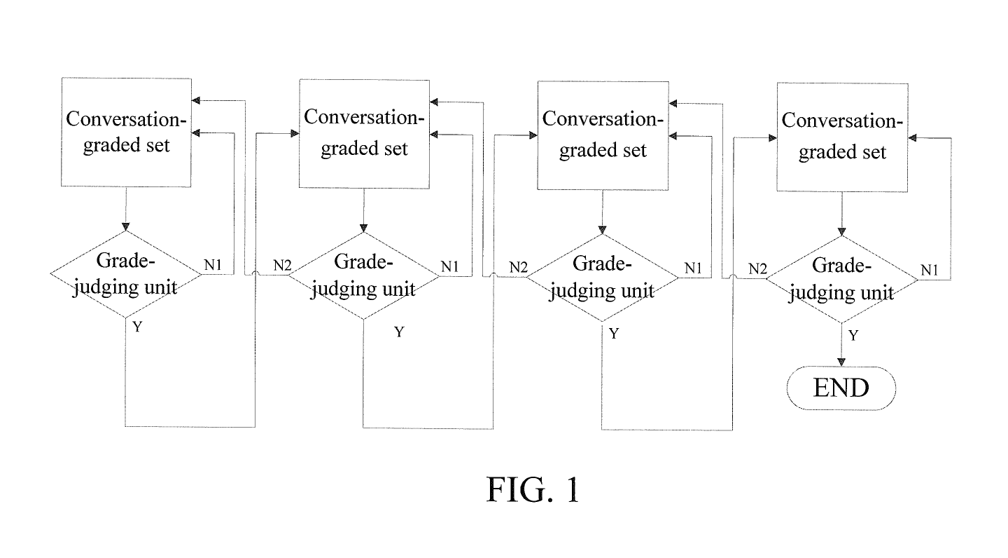

Referring initially to FIG. 1, a block diagram of an adaptive foreign-language-learning conversation system having a dynamically adjustable function in accordance with a preferred embodiment of the present invention is shown. The adaptive foreign-language-learning conversation system of the preferred embodiment of the present invention includes a plurality of conversation-graded sets and a plurality of grade-judging units. The grade-judging units connect with the corresponding conversation-graded sets such that the grade judging unit is operated to upgrade or downgrade a level of the conversation-graded set, or maintain the same level of the conversation-graded sets. The levels of the conversation-graded sets are designated according to grades thereof so that different levels of the conversation-graded sets are suitable for different learning efficiencies of individual users. Advantageously, the adaptive foreign-language-learning conversation system of the present invention can provide various levels of the conversation-graded sets according to individual users, or can be adjusted to change the level of the conversation-graded set according to different learning efficiencies.

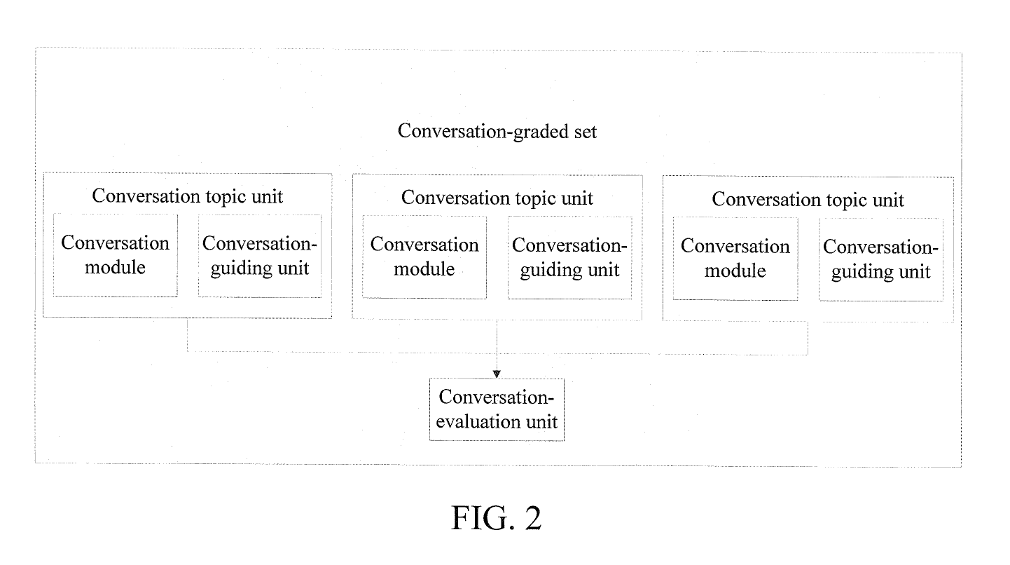

Turning now to FIG. 2, a block diagram of conversation-graded sets applied in the adaptive foreign-language-learning conversation system in accordance with the preferred embodiment of the present invention is shown. Referring to FIG. 2, each of the conversation-graded sets includes a plurality of conversation topic units and at least one or several conversation-evaluating unit. By way of example, the conversation topic units include various shopping conversation topics, various restaurant conversation topics, various asking-for-direction conversation topics and other conversation topics which are not limitative of the present invention.

Still referring to FIG. 2, each of the conversation topic units has a conversation module and a conversation-guiding unit connected thereto. The conversation-guiding unit is used to generate an option of predetermined conversation sentences in the corresponding conversation module while the system is unsuccessful in identifying a user's response sentence. In conversation-training operation, the conversation module is used to generate foreign-language conversation sentences (e.g. question sentences or answer sentences) and to receive and identify user's response sentences (e.g. answer sentences or question sentences).

With continued reference to FIG. 2, the conversation-evaluating unit connects with output ends of the conversation topic units provided in each of the conversation-graded sets. According to the user's response sentence, the conversation topic unit is operated to send identification data via the output end to the conversation-evaluating unit which can generate an evaluation result which can be sent to the corresponding grade-judging unit, as best shown in FIG. 1.

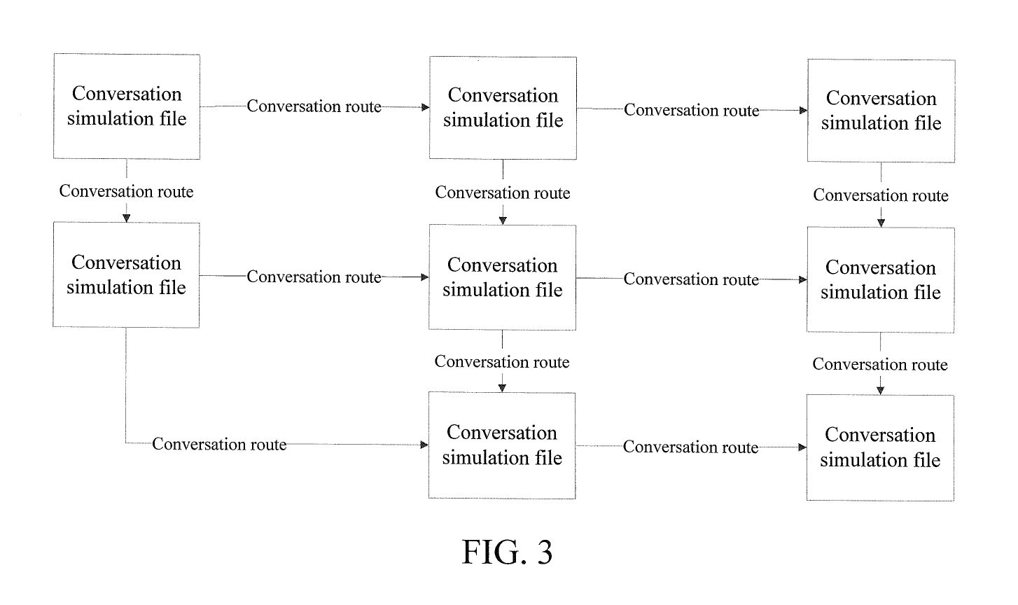

Turning now to FIG. 3, a block diagram of conversation modules applied in the adaptive foreign-language-learning conversation system in accordance with the preferred embodiment of the present invention is shown. Referring to FIG. 3, the conversation module includes a plurality of predetermined conversation sentences, a plurality of conversation indexes and a plurality of conversation routes. A set of the predetermined conversation sentences is consisted in a conversation simulation file. In the preferred embodiment, the predetermined conversation sentences are in the form of various question sentences and answer sentences, wherein the corresponding question sentences connect with the corresponding answer sentences so as to form a number of the conversation simulation files. The conversation routes link the associated conversation simulation files such that the user can execute a series of the conversation simulation files along the conversation routes for conversation simulation. Each of the predetermined conversation sentences has a connection with the corresponding conversation index. When the system is successful in identifying the user's response sentence, the corresponding conversation index can be generated. In a preferred embodiment, the conversation index reflects a systematical evaluation of the users' conversation ability and is selected from a complex index, for example, including a logic value, a pronunciation value, a grammar value or other functional values which are not limitative of the present invention.

Referring again to FIGS. 2 and 3, the conversation simulation files are formed as steps of situational conversation of learning operation. According to the situational conversation, the user can start the suitable conversation simulation file, change from it to the next file along the conversation routes, as best shown in directions of arrows in FIG. 3, to the last file in each of the conversation modules. To finish the conversation topic unit the user may execute all of the conversation simulation files. In operation, the conversation module is executed to generate one of the predetermined conversation sentences. In response to the conversation sentence the user must reply a sentence (e.g. audio message), as a user's response sentence, to the system. Once received, the system identifies the user's response sentence with the predetermined conversation sentences to generate at least one suitable conversation index such that the conversation topic unit can generate a series of individual identification data to send to the conversation-evaluating unit. When the system is successful in identifying the user's response sentence, the system allows the user to execute the next conversation simulation file. Conversely, when the system is unsuccessful in identifying the user's response sentence, the associated conversation-guiding unit is executed to generate at least option of the designated conversation sentences. In this circumstance, the user can take an option of the designated conversation sentences as a user's response sentence. Accordingly, a suitable conversation index will be generated.

Referring back to FIG. 1, the grade-judging unit includes a first predetermined value and a second predetermined value which are used to upgrade or downgrade the levels of the conversation-graded sets, or to maintain the same level of the conversation-graded sets according to the evaluation result. The level of the conversation-graded set is upgraded to the higher level when the evaluation result of the individual user determined by the grade-judging unit is greater than the first predetermined value and is identified as “Y”. If the level of the conversation-graded set is highest, the conversation system will be ended. The level of the conversation-graded set is maintained at the same level, when the evaluation result of the individual user is not greater than the first predetermined value but greater than the second predetermined and is identified as “N1”. The level of the conversation-graded set is downgraded to the lower level when the evaluation result of the individual user is not greater than the second predetermined value and is identified as “N2”. If the level of the conversation-graded set is lowest, the level of the conversation-graded set will be maintained.

Although the invention has been described in detail with reference to its presently preferred embodiment(s), it will be understood by one of ordinary skill in the art that various modifications can be made without departing from the spirit and the scope of the invention, as set forth in the appended claims.

What is claimed is:

1. An adaptive foreign-language-learning conversation system comprising:
a plurality of conversation-graded sets executed to simulate foreign language learning;
a plurality of conversation topic units provided in the corresponding conversation-graded sets;
a plurality of conversation modules provided in the corresponding conversation topic units, each of the conversation modules including predetermined conversation sentences, conversation indexes and conversation routes, the predetermined conversation sentences defining a plurality of conversation simulation files, the conversation modules used to generate one of the conversation sentences and to receive and identify a user's response sentence; and
at least one conversation-evaluating unit provided in at least one of the conversation-graded sets to connect with output ends of the conversation topic units, the conversation-evaluating unit used to generate an evaluation result while executing the conversation module of the conversation topic unit for simulating conversation;
wherein the system is operated to upgrade or downgrade levels of the conversation-graded sets, or to maintain the same level of the conversation-graded sets according to the evaluation result.

2. The adaptive foreign-language-learning conversation system as defined in claim 1, wherein the system further includes a plurality of grade-judging units connecting with the corresponding conversation-graded sets, and the grade-judging unit is used to upgrade or downgrade the levels of the conversation-graded sets, or to maintain the same level of the conversation-graded sets according to the evaluation result.

3. The adaptive foreign-language-learning conversation system as defined in claim 2, wherein the grade-judging unit includes a first predetermined value and a second predetermined value which are used to upgrade or downgrade the levels of the conversation-graded sets, or to maintain the same level of the conversation-graded sets.

4. The adaptive foreign-language-learning conversation system as defined in claim 1, wherein the conversation module connects with a conversation-guiding unit which is used to generate at least one option of the predetermined conversation sentences in the conversation module while the system is unsuccessful in identifying the user's response sentence.

5. The adaptive foreign-language-learning conversation system as defined in claim 1, wherein the predetermined conversation sentences are in the form of various question sentences and answer sentences.

6. The adaptive foreign-language-learning conversation system as defined in claim 1, wherein the conversation route links the associated conversation simulation files of the conversation modules.

7. The adaptive foreign-language-learning conversation system as defined in claim 1, wherein the predetermined conversation sentences of the conversation modules connect with the conversation indexes.

8. The adaptive foreign-language-learning conversation system as defined in claim 1, wherein the conversation indexes are selected from a complex index.
